(19) United States
(12) Patent Application Publication
(10) Pub. No.: US 2019/0256670 A1
(43) Pub. Date: Aug. 22, 2019

(54) METHOD FOR PRODUCING RUBBER WET MASTER BATCH

(71) Applicant: TOYO TIRE CORPORATION, Itami-shi, Hyogo (JP)

(72) Inventor: Yuya KONNO, Itami-shi (JP)

(73) Assignee: TOYO TIRE CORPORATION, Itami-shi, Hyogo (JP)

(21) Appl. No.: 16/341,238

(22) PCT Filed: Jul. 21, 2017
(86) PCT No.: PCT/JP2017/026441

§ 371 Date: Apr. 11, 2019

(30) Foreign Application Priority Data
Dec. 28, 2016 (JP) 2016-256577

(51) Int. Cl. C08J 3/22; C08J 3/05; C08L 7/02

(52) U.S. Cl. CPC C08J 3/226; C08J 3/05; C08L 2310/00; C08L 2201/52; C08L 2205/025; C08L 7/02

(57) ABSTRACT

A method for producing a rubber wet master batch using, as raw materials, at least a rubber powder, a filler, a dispersing solvent, and a rubber latex solution, comprises a step (I) of adding, at a time of dispersing the rubber powder in the dispersing solvent, at least one portion of the rubber latex solution to the dispersing solvent to produce a rubber powder solution containing the rubber powder to which rubber latex particles adhere, a step (II) of adding the filler to the rubber powder solution, and mixing the solution and the filler with each other to produce a rubber-powder-containing slurry solution, and a step (III) of mixing the rubber-powder-containing slurry solution with a rest of the rubber latex solution, and then solidifying/drying the resultant mixture.

### TECHNICAL FIELD

The present invention relates to a method for producing a rubber wet master batch using, as raw materials, at least a rubber powder, a filler, a dispersing solvent, and a rubber latex solution.

### BACKGROUND ART

Hitherto, waste tires and other rubber product wastes have been reused, and reused as fuels, for example, in cement factories. In recent years, under the consideration of environmental problems, a material recycle been recommended, in which waste tires and others are pulverized and the resultant is used, as it is, as rubber pieces or rubber powder. However, when rubber powder yielded by pulverizing waste tires or others into fine particles is mixed with a new rubber, the following problem is caused: a vulcanized rubber yielded by vulcanizing the resultant rubber composition is deteriorated in physical properties, for example, tear strength.

Apart from the above, it has been hitherto known in the rubber industry that when a rubber composition containing a filler such as carbon black is produced, a rubber wet master batch is used to improve the workability of the composition and the dispersibility of the filler therein. This technique is a technique of mixing the filler and a dispersing solvent beforehand with each other at a predetermined ratio, dispersing the filler into the dispersing solvent by mechanical force, mixing the resultant filler-containing slurry solution with a rubber latex solution in a liquid phase, adding a solidifier such as an acid, after the mixing, to the mixture to solidify the mixture, collecting the solidified mixture, and then drying the mixture. The use of the rubber wet master batch gives a rubber composition better in dispersibility of the filler therein, and in rubber physical properties, such as tear strength, than the use of a rubber dry master batch yielded by mixing a filler and rubber with each other in a solid phase.

There are techniques of blending a rubber powder into a rubber wet master batch. For example, Patent Document 1 described below reports a technique of mixing a rubber latex with a slurry solution in which a filler and a rubber powder are beforehand dispersed in water. Moreover, Patent Document 2 described below reports the following technique: a method, for producing a natural rubber wet master batch, which includes at least a step of mixing a natural rubber latex with a slurry solution in which carbon black is beforehand dispersed in water, this method being a method in which 1 to 40 parts by weight of a powdery rubber is mixed with the other raw materials in producing steps of the master batch until the raw materials are dried.

### PRIOR ART DOCUMENTS

### Patent Documents

Patent Document 1: JP-A-2007-217677
Patent Document 2: JP-A-2007-231153

### SUMMARY OF THE INVENTION

### Problems to be Solved by the Invention

However, the inventors have made eager investigations to find out that a rubber wet master batch yielded by each of the producing methods described in the above-mentioned patent documents cannot yet restrain, with ease, a disadvantage caused when a rubber powder is blended into the master batch, that is, a deterioration of the resultant vulcanized rubber in rubber physical properties, in particular, for example, tear strength.

In the light of the above-mentioned actual situation, the present invention has been made. An object thereof is to provide a method for producing a rubber wet master batch which contains an evenly-dispersed rubber powder and which is a raw material for a vulcanized rubber excellent in tear strength.

### Means for Solving the Problems

The object can be attained by the present invention as described below. Accordingly, the method according to the present invention for producing a rubber wet master batch is a method for producing a rubber wet master batch, using, as raw materials, at least a rubber powder, a filler, a dispersing solvent, and a rubber latex solution, including: a step (I) of adding, at the time of dispersing the rubber powder in the dispersing solvent, at least one portion of the rubber latex solution to the dispersing solvent to produce a rubber powder solution containing the rubber powder to which rubber latex particles adhere, a step (II) of adding the filler to the rubber powder solution, and mixing the solution and the filler with each other to produce a rubber-powder-containing slurry solution, and a step (III) of mixing the rubber-powder-containing slurry solution with a rest of the rubber latex solution, and then solidifying/drying the resultant mixture.

According to the producing method, at the time of dispersing a rubber powder in a dispersing solvent, at least one portion of a rubber latex solution is added to the dispersing solvent to produce a rubber powder solution containing the rubber powder to which rubber latex particles adhere (step (I)). In this way, a very thin latex phase is produced on a portion or the whole of the surface of the rubber powder. Thus, when the rubber powder is to be mixed with the rest of the rubber latex solution in the step (III), the rubber powder can be prevented from being again aggregated. As a result, the rubber powder can be evenly dispersed to produce a rubber wet master batch containing the rubber powder excellent in dispersion stability also with the passage of time. As a result, the present invention allows to restrain a deterioration of the resultant vulcanized rubber in physical properties which is caused by the blend of the rubber powder, so as to produce a rubber wet master batch that is a raw material of the vulcanized rubber, which is excellent in tear strength.

In this method for producing a rubber wet master batch, it is preferred that a solid (rubber) amount in the rubber latex solution to be added in the step (I) is from 0.25 to 20% by mass of the rubber powder. In the step (I), it is preferred that a solid (rubber) concentration in the rubber latex solution to be added is from 0.2 to 5% by mass. In these manners, the rubber powder is especially good in dispersibility, so that the finally obtained vulcanized rubber is in particular improved in tear strength.

The present invention further relates to a method for producing a rubber composition containing at least a rubber wet master batch, in which the rubber wet master batch is produced by any one of the above-described producing method. This producing method allows to produce a rubber composition in which the rubber powder is excellent in dispersibility, so as to improve the finally obtained vulcanized rubber in tear strength.

### MODE FOR CARRYING OUT THE INVENTION

In the method according to the present invention, at the time of dispersing a rubber powder into a dispersing solvent, at least one portion of a rubber latex solution is added to the dispersing solvent to produce a slurry solution containing the rubber powder to which rubber latex particles adhere (step (I)); a filler is then added to the resultant rubber powder solution, and the solution and the filler are mixed with each other (step (II)); and then the resultant rubber-powder-containing slurry solution is mixed with a rest of the rubber latex solution, and then the resultant mixture is solidified/dried (step (III)).

The rubber powder usable in the present invention is preferably a rubber powder which has been at least partially vulcanized. In particular, when environmental problems are considered, the rubber powder is preferably a rubber powder yielded by pulverizing regenerated rubber obtained using a used tire as a raw material. When consideration is made about the tensile strength and the tear strength of the resultant vulcanized rubber, and the workability of the resultant tire member, the particle diameter of the resultant rubber powder is preferably 100 mesh or less, more preferably 200 mesh or less, the definition of “mesh” being according to ASTM D5644-01.

In the present invention, the filler means an inorganic filler used ordinarily in the rubber industry, such as carbon black, silica, clay, talc, calcium carbonate, magnesium carbonate, and aluminum hydroxide. Out of these inorganic fillers, carbon black is in particular preferably usable in the present invention.

The species of the carbon black is a carbon black species used in an ordinary rubber industry, such as SAF, ISAF, HAF, FEF, or GPF. The carbon black species may be an electroconductive carbon black species such as acetylene black or Ketchen black. The carbon black species may be any granulated carbon black species, which has been granulated, considering the handleability of the carbon black species in an ordinary rubber industry; or a non-granulated carbon black species.

The dispersing solvent is in particular preferably water, and may be, for example, water containing an organic solvent.

As the rubber latex solution, a natural rubber latex solution and a synthetic rubber latex solution are usable.

The natural rubber latex solution is a natural product based on a metabolic effect of plants, and is preferably a natural-rubber/water based latex solution in which a dispersing solvent is, particularly, water. The number-average molecular weight of the natural rubber in the natural rubber latex used in the present invention is preferably 2,000,000 or more, more preferably 2,500,000 or more. The synthetic rubber latex solution is, for example, a latex solution in which a rubber is produced by emulsion polymerization, examples of this rubber including styrene-butadiene rubber, butadiene rubber, nitrile rubber, and chloroprene rubber.

The following will describe the method according to the present invention for producing a rubber wet master batch. In the present embodiment, the description is, in particular, about an example of using carbon black as the filler, and using a natural rubber latex solution as the rubber latex solution. About the natural rubber latex solution, the following may be used without being distinguished from each other: a concentrated latex, a fresh latex called field latex, and others.

This producing method includes a step (I) of adding, at the time of dispersing the rubber powder in the dispersing solvent, at least one portion of a rubber latex solution to the dispersing solvent to produce a rubber powder solution containing the rubber powder to which rubber latex particles adhere, a step (II) of adding a filler to the rubber powder solution, and mixing the solution and the filler with each other to produce a rubber-powder-containing slurry solution, and a step (III) of mixing the rubber-powder-containing slurry solution with a rest of the rubber latex solution, and then solidifying/drying the resultant mixture.

### (1) Step (I)

In the step (I), at the time of dispersing a rubber powder in a dispersing solvent, at least one portion of a rubber latex solution is added to the dispersing solvent to produce a rubber powder solution containing the rubber powder to which natural rubber latex particles adhere. About the natural rubber latex solution, it is allowable to mix the solution beforehand with the dispersing solvent, and then add the rubber powder thereto to disperse the rubber powder in the mixture. It is also allowable to add the rubber powder to the dispersing solvent, and next disperse the rubber powder into the dispersing solvent while adding the natural rubber latex solution to the dispersing solvent at a predetermined adding speed; or add the rubber powder into the dispersing solvent, and next disperse the rubber powder into the dispersing solvent while adding a predetermined volume of the natural rubber latex solution into the dispersing solvent several times through operations separated from each other. By dispersing the rubber powder into the dispersing solvent in the presence of the natural rubber latex solution, the rubber powder solution can be produced, which contains the rubber powder to which the natural rubber latex particles adhere. The addition amount of the natural rubber latex solution in the step (I) is, for example, from 0.075 to 12% by mass of the whole of the natural rubber latex solution to be used (the whole of fractions of this latex solution that are to be added in the step (I) and in the step (II)).

In the step (I), the solid (rubber) amount in the natural latex solution to be added is preferably from 0.25 to 15%, more preferably from 0.5 to 6% by mass of the rubber powder. The solid (rubber) concentration in the natural rubber latex solution to be added is preferably from 0.2 to 5% by mass, more preferably from 0.25 to 1.5% by mass. In these cases, a rubber wet master batch can be produced in which the natural rubber latex particles are surely caused to adhere to the rubber powder, and simultaneously in which the dispersion degree of the rubber powder is heightened.

In the step (I), the method for mixing the rubber powder with the dispersing solvent in the presence of the natural rubber latex solution is, for example, a method of dispersing carbon black, using an ordinary dispersing machine such as a highly shearing mixer, a High Shear Mixer, a homo-mixer, a ball mill, a bead mill, a high-pressure homogenizer, an ultrasonic homogenizer or a colloid mill.

The “highly shearing mixer” means a mixer having a high-speed-rotatable rotor and a fixed stator in which the rotor is rotated in the state of setting a precise clearance between the rotor and the stator, so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. An example thereof is a mixer, “High Shear Mixer”, manufactured by a company Silverson.

In the present invention, at the time of mixing the rubber powder with the dispersing solvent in the presence of the natural rubber latex solution to produce the rubber powder solution, which contains the rubber powder to which the natural rubber latex particles adhere, a surfactant may be added thereto in order to improve the rubber powder in dispersibility. The surfactant may be a surfactant known in the rubber industry. Examples thereof include nonionic surfactants, anionic surfactants, cationic surfactants, and amphoteric surfactants. Instead of the surfactant or in addition of the surfactant, an alcohol such as ethanol may be used. However, when the surfactant is used, it is feared that the finally obtained vulcanized rubber is lowered in rubber physical properties. Thus, the blend amount of the surfactant is preferably 2 parts or less by mass, more preferably 1 part or less by mass for 100 parts by mass of the solid (rubber) in the natural rubber latex solution. It is preferred not to use any surfactant substantially.

### (2) Step (II)

The step (II) includes operations of adding a filler to the rubber powder solution, and mixing the solution and the filler with each other to produce a rubber-powder-containing slurry solution. It is allowable to add carbon black, as it is, to the rubber powder solution; or to disperse carbon black beforehand into the dispersing solvent, and then add the resultant in a slurry state to the rubber powder solution. Furthermore, it is allowable that when carbon black is dispersed into the dispersing solvent, at least one portion of the natural rubber latex solution is added thereto to produce a slurry solution containing the carbon black to which natural rubber latex particles adhere, and then this solution is added to the rubber powder solution.

### (3) Step (III)

The step (III) includes an operation of mixing the rubber-powder-containing slurry solution with a rest of the natural rubber latex solution. The method for mixing the rubber-powder-containing slurry solution with the rest of the natural rubber latex solution in a liquid phase is not particularly limited, and is, for example, a method of mixing the rubber-powder-containing slurry solution with the rest of the natural rubber latex solution, using an ordinary dispersing machine such as a highly shearing mixer, a High Shear Mixer, a homo-mixer, a ball mill, a bead mill, a high-pressure homogenizer, an ultrasonic homogenizer or a colloid mill. As required, at the time of the mixing, the whole of the mixing system, such as the dispersing machine, may be heated.

In the case of considering the drying period and labor in a post step, the solid (rubber) concentration in the rest of the natural rubber latex solution is preferably higher than that in the natural rubber latex solution added in the step (I). Specifically, the solid (rubber) concentration is preferably from 10 to 60% by mass, more preferably from 20 to 30% by mass.

In the step (III), furthermore, the rubber-powder-containing slurry solution is mixed with the rest of the rubber latex solution, and then the mixture is solidified/dried. The method for the solidifying/drying is, for example, a solidifying/drying method of incorporating a solidifier into the mixture solution of the rubber-powder-containing slurry solution and the rest of the rubber latex solution to solidify the mixture, and subsequently drying the resultant; or an exsiccating method of drying the mixture without solidifying the mixture.

Usable examples of the solidifier in the solidifying/drying method include acids such as formic acid and sulfuric acid, and salts such as sodium chloride, these acids or salts being ones usually used to solidify a rubber latex solution.

In the method for drying the mixture solution after the mixing of the rubber-powder-containing slurry solution with the rest of the rubber latex solution, various drying machines are usable, examples thereof including an oven, a vacuum drier, and an air drier.

It is allowable in the present invention to incorporate a coagulant into the mixture solution of the rubber-powder-containing slurry solution and the rest of the rubber latex solution, and then collet and dry the resultant coagulated product. It is possible to use, as the coagulant, a substance known as a coagulant for rubber latex solutions without any limitation. Specific examples thereof include cationic coagulants.

The rubber wet master batch yielded through/after the step (III) preferably contains 1 to 40 parts by mass of the rubber powder for 100 parts by mass of the rubber. In this case, the rubber powder is evenly dispersed so that the master batch can be a raw material for a vulcanized rubber excellent in tear strength.

Moreover, the rubber wet master batch yielded through/after the step (III) preferably contains 70 parts or less by mass of the filler for 100 parts by mass of the rubber. In this case, a rubber wet master batch can be produced which is improved, with a good balance, in the dispersion degree of the filler therein, and in the exothermicity and endurance of a vulcanized rubber yielded when this master batch is vulcanized.

A rubber composition related to the present invention can be produced by blending any blending agent used ordinarily in the rubber industry into the wet master batch yielded through/after the step (III). Examples of the agent include a sulfur-containing vulcanizer, a vulcanization promoter, silica, a silane coupling agent, zinc oxide, stearic acid, a vulcanization promotion aid, a vulcanization retardant, an organic peroxide, an antiaging agent, softening agents such as wax and oil, and a working aid.

The species of sulfur as the sulfur-containing vulcanizer may be an ordinary sulfur species for rubbers, and may be, for example, powdery sulfur, precipitated sulfur, insoluble sulfur, or highly dispersible sulfur. The sulfur content in the rubber composition related to the present invention for tires is preferably from 0.3 to 6.0 parts by mass for 100 parts by mass of the rubber component. If the sulfur content is less than 0.3 parts by mass, the vulcanized rubber is short in crosslinkage density to be lowered in rubber strength and others. If the content is more than 6.0 parts by mass, the vulcanized rubber is deteriorated, in particular, in both of heat resistance and endurance. The sulfur content is more preferably from 1.0 to 4.5 parts, even more preferably from 1.4 to 2.8 parts by mass for 100 parts by mass of the rubber component to cause the vulcanized rubber to keep a good rubber strength surely and be made better in heat resistance and endurance.

The vulcanization promoter may be a vulcanization promoter used usually for rubber vulcanization. Examples thereof include sulfenamide type, thiuram type, thiazole type, thiourea type, guanidine type, and dithiocarbamic acid salt type vulcanization promoters. Such promoters may be used singly or in an appropriate mixture form. The vulcanization promoter content is more preferably from 1.0 to 5.0 parts by mass, even more preferably from 1.5 to 4.0 parts by mass for 100 parts by mass of the rubber component.

The antiaging agent may be an antiaging agent used usually for rubbers. Examples thereof include aromatic amine type, amine-ketone type, monophenolic type, bisphenolic type, polyphenolic type, dithiocarbamic acid salt type, and thiourea type antiaging agents. Such agents may be used singly or in an appropriate mixture form. The antiaging agent content is more preferably from 0.3 to 3.0 parts by mass, even more preferably from 0.5 to 2.0 parts by mass for 100 parts by mass of the rubber component.

The rubber composition related to the present invention can be yielded by using a mixing machine used in an ordinary rubber industry, such as a Banbury mixer, a kneader or a roll, to mix and knead the rubber wet master batch, and optional components, such as a sulfur-containing vulcanizer, a vulcanization promoter, silica, a silane coupling agent, zinc oxide, stearic acid, a vulcanization promotion aid, a vulcanization retardant, an organic peroxide, an antiaging agent, softening agents such as wax and oil, and a working aid.

The method for blending the above-mentioned individual components with each other is not particularly limited, and may be, for example, any one of the following: a method of kneading, in advance, kneading components other than the sulfur-containing vulcanizer, the vulcanization promoter and other vulcanization-related components to prepare a master batch, adding the remaining components thereto, and further kneading the resultant; a method of adding the individual components in any order to a machine as described above, and then kneading the resultant; and a method of adding all the components simultaneously to the same machine, and kneading the resultant.

### EXAMPLES

Hereinafter, this invention will be more specifically described by demonstrating working examples thereof. Raw materials and devices used therein are as follows:

### (Used Raw Materials)

a) Rubber component: NR: “RSS#3” (Tg=−60° C.);
b) Filler (carbon black (CB)): “SEAST KH”, manufactured by Tokai Carbon Co., Ltd. (N2SA: 93 m²/g, and DBP: 119 cm³/100 g);
c) Zinc flower: “Zinc Flower No. 1”, manufactured by Mitsui Mining & Smelting Co., Ltd.;
d) Antiaging agent: “NOCRAC 6C” (N-(1,3-dimethylbutyl)-N′-phenyl-p-phenylenediamine, 6PPD), manufactured by Ouchi Shinko Chemical Industrial Co., Ltd.;
e) Stearic acid: “LUNAC S20”, manufactured by Kao Corp.;
f) Rubber powders:

Rubber powder 1 (PD 140): “PolyDyne 140”, manufactured by a company Lehigh (according to ASTM D5644-01; 120 mesh (125 μm): <1 (% retained), 140 mesh (105 μm): <10 (% retained), and minus 200 mesh (75 μm): >30 (% retained)), and

Rubber powder 2 (PD 200): “PolyDyne 200”, manufactured by the company Lehigh (according to ASTM D5644-01; 170 mesh (88 μm): <1 (% retained), and 200 mesh (74 μm): <10 (% retained));

g) Sulfur: “POWDERY SULFUR”, manufactured by Tsurumi Chemical Industry Co., Ltd.; and
h) Vulcanization promoter: “SOXINOL CZ”, manufactured by Sumitomo Chemical Co., Ltd.

### (Evaluations)

A predetermined mold was used to heat and vulcanize each rubber composition at 150° C. for 30 minutes. The resultant rubber was evaluated.

### (Tensile Property of Vulcanized Rubber)

According to JIS K 6251, the rubber was subjected to a tensile test (using a dumbbell, No. 3 model at an atmosphere temperature of 23° C.). About an evaluation thereof, the result value is represented as an index relative to a value of Comparative Example 1, which is regarded as 100. It is demonstrated that as the rubber is larger in the value, the rubber is better in tensile strength and tensile elongation.

### (Tear Strength of Vulcanized Rubber)

The tear strength of the rubber was measured according to JIS K 6252. About an evaluation thereof, the result value is represented as an index relative to a value of Comparative Example 1, which is regarded as 100. It is demonstrated that as the rubber is larger in the value, the rubber is better in tear strength.

### Example 1

Into a dilute latex solution in water (solid (rubber) amount: 1.3 parts by mass) adjusted into a concentration of 0.5% by mass were added 20 parts by mass of the rubber powder 1. A machine ROBOMIX manufactured by Primix Corp. was used (ROBOMIX condition: 9000 rpm for 30 minutes) to disperse the rubber powder into this latex solution to produce a rubber powder solution in which natural rubber latex particles adhered to the rubber powder (step (I)).

Next, 50 parts by mass of the carbon black were added to the rubber powder solution containing the rubber powder 1 to which the natural rubber latex particles adhered, and these components were mixed with each other to produce a rubber-powder-containing slurry solution. Furthermore, the rest of the natural rubber latex solution (solution adjusted into a solid (rubber) concentration of 25% by mass by the addition of water) was combined with the natural rubber latex solution used in the step (I), and was added to the latter latex solution to give a solid (rubber) content of 100 parts by mass. Next, a mixer for home use, SM-L56 model, manufactured by Sanyo Corp., was used (mixer conditions: 11300 rpm for 30 minutes) to mix the components with each other (step (II)).

Next, thereto was added a 10%-by-mass formic acid solution in water until the present system turned into a pH of 4. A screw press, V-01 model, manufactured by Suehiro EPM Corp. was used to dry the resultant solidified product until the water content by percentage therein turned to 1.5% or less. In this way, a natural rubber latex solution (WMB2) was produced (step (III)).

Various blending agents shown in Table 1 were blended into the resultant natural wet master batch (WMB2) to prepare a rubber composition. Physical properties of a vulcanized rubber therefrom were measured. The results are shown in Table 1.

### Example 2

A rubber wet master batch (WMB3), a rubber composition, and a vulcanized rubber were prepared in the same way as in Example 1 except that the used rubber powder was changed to a rubber powder shown in Table 1.

### Comparative Examples 1 to 3

In Comparative Example 1, a rubber composition was produced by kneading a natural rubber and the various blending gents under dry conditions. Also in each of Comparative Examples 2 and 3, a rubber composition was produced by kneading the natural rubber, one of the rubber powders, and the various blending agents under dry conditions.

### Comparative Example 4

One of the rubber powders was blended into a rubber wet master batch (WMB1) shown in Table 1, and these components were kneaded under dry conditions to produce a rubber composition.

### Comparative Example 5

A rubber wet master batch (WMB2), a rubber composition, and a vulcanized rubber were prepared in the same way as in Example 1 except that the step (I) was changed to a step of mixing the rubber powder with the carbon black in the dispersing solvent, the step (II) was omitted, and the step (III) was changed to a step of adding the natural rubber latex solution into the system, and mixing the components in the system with each other.

### Comparative Example 6

A rubber wet master batch (WMB2), a rubber composition, and a vulcanized rubber were prepared in the same way as in Example 1 except that the step (I) was changed to a step of dispersing the carbon black into the dispersing solvent, the step (II) was omitted, and the step (III) was changed to a step of adding the rubber powder and the natural rubber latex solution into the system, and mixing these components in the system with each other.

TABLE 1

| | Comparative | Comparative | Comparative | Comparative | Comparative | Comparative | | |
|---|---|---|---|---|---|---|---|---|
| Blending agent | Example 1 | Example 2 | Example 3 | Example 4 | Example 5 | Example 6 | Example 1 | Example 2 |
| NR | 100 | 100 | 100 | | | | | |
| WMB1 | | | | 150 | | | | |
| (NR/CB) | | | | (100/50) | | | | |
| WMB2 | | | | | 170 | 170 | 170 | |
| (NR/CB/PD140) | | | | | (100/50/20) | (100/50/20) | (100/50/20) | |
| WMB3 | | | | | | | | 170 |
| (NR/CB/PD200) | | | | | | | | (100/50/20) |
| Carbon black | 50 | 50 | 50 | | | | | |
| Zinc flower | 3 | 3 | 3 | 3 | 3 | 3 | 3 | 3 |
| Antiaging agent | 2 | 2 | 2 | 2 | 2 | 2 | 2 | 2 |
| Stearic acid | 2 | 2 | 2 | 2 | 2 | 2 | 2 | 2 |
| Wax | 2 | 2 | 2 | 2 | 2 | 2 | 2 | 2 |
| PD140 | | 20 | | 20 | | | | |
| PD200 | | | 20 | | | | | |
| Sulfur | 2 | 2 | 2 | 2 | 2 | 2 | 2 | 2 |
| Valcanization | 2 | 2 | 2 | 2 | 2 | 2 | 2 | 2 |
| promoter | | | | | | | | |
| Rolling | 100 | 110 | 89 | 99 | | | | |
| resistance | | | | | | | | |
| Tensile | 100 | 88 | 90 | 94 | 96 | 95 | 100 | 103 |
| property | | | | | | | | |
| Tear strength | 100 | 92 | 93 | 98 | 100 | 99 | 104 | 106 |

1.-4. (canceled)

5. A method for producing a rubber wet master batch using, as raw materials, at least a rubber powder, a filler, a dispersing solvent, and a rubber latex solution, comprising:
a step (I) of adding, at a time of dispersing the rubber powder in the dispersing solvent, at least one portion of the rubber latex solution to the dispersing solvent to produce a rubber powder solution containing the rubber powder to which rubber latex particles adhere,
a step (II) of adding the filler to the rubber powder solution, and mixing the solution and the filler with each other to produce a rubber-powder-containing slurry solution, and
a step (III) of mixing the rubber-powder-containing slurry solution with a rest of the rubber latex solution, and then solidifying/drying the resultant mixture.

6. The method for producing a rubber wet master batch according to claim 5, wherein a solid (rubber) amount in the rubber latex solution to be added in the step (I) is from 0.25 to 20% by mass of the rubber powder.

7. The method for producing a rubber wet master batch according to claim 5, wherein in the step (I), a solid (rubber) concentration in the rubber latex solution to be added is from 0.2 to 5% by mass.

8. The method for producing a rubber wet master batch according to claim 5, wherein the filler is a carbon black.

9. The method for producing a rubber wet master batch according to claim 5, wherein the rubber latex solution is a natural rubber latex solution.

10. The method for producing a rubber wet master batch according to claim 5, wherein the rubber wet master batch yielded through/after the step (III) contains 1 to 40 parts by mass of the rubber powder for 100 parts by mass of the rubber.

11. The method for producing a rubber wet master batch according to claim 5, wherein the rubber wet master batch yielded through/after the step (III) contains 70 parts or less by mass of the filler for 100 parts by mass of the rubber.

12. A method for producing a rubber composition containing at least a rubber wet master batch,
wherein the rubber wet master batch is produced by the producing method recited to claim 5.
